(19) United States
(12) Patent Application Publication
(10) Pub. No.: US 2025/0196778 A1
(43) Pub. Date: Jun. 19, 2025

(54) MOVEABLE TRUCK BED ORGANIZER

(71) Applicant: Harish Sanath Kumar, San Jose, CA (US)

(72) Inventor: Harish Sanath Kumar, San Jose, CA (US)

(21) Appl. No.: 18/543,187

(22) Filed: Dec. 18, 2023

(51) Int. Cl. B60R 9/06; B62D 33/02

(52) U.S. Cl. CPC B60R 9/06; B62D 33/0207

(57) ABSTRACT

A vehicle includes a truck bed with a movable platform disposed over the truck bed. The truck bed includes multiple tracks. The platform includes a top surface and a bottom surface. The vehicle further includes multiple glides attached to the bottom surface of the platform. The glides engage with the tracks. The glides slide in the respective tracks so that the platform slides in and out of the truck bed.

### BACKGROUND OF THE INVENTION

### Field of the Invention

The present invention generally relates to a moveable truck bed organizer, and more specifically to a moveable truck bed organizer that enables a user to securely store one or more items on a truck cargo bed.

### Description of the Related Art

Typically, vehicle owners must climb onto the truck bed of a truck to place/retrieve items placed on the truck bed. Sometimes, climbing onto the truck bed to place/retrieve items multiple times may be cumbersome for a user, and may even result in injury. In addition, the items placed on the truck bed may slide during vehicle movement, which may damage the items.

People generally use bins to store the items on the truck bed; however, the bins are also susceptible to sliding when the vehicle moves, thereby causing damage to items stored in the bins.

Therefore, there is a need for a system that enables users to conveniently place/retrieve items from the truck bed without climbing, and which prevents item movement during vehicle movement.

### SUMMARY OF THE INVENTION

The following presents a simplified summary of the present disclosure in a simplified form as a prelude to the more detailed description that is presented herein.

In accordance with embodiments of the invention, there is provided a vehicle that includes a truck bed having a plurality of tracks. The vehicle may further include a platform disposed over the truck bed. The platform may include a top surface and a bottom surface. The vehicle may further include a plurality of glides attached to the bottom surface of the platform. The plurality of glides may be configured to engage with the plurality of tracks. Further, the plurality of glides may be configured to slide in the respective tracks to facilitate sliding the platform in and out of the truck bed. Alternatively, the rail system may in some instances be integrated or embedded into the bed of the truck rather than installing a separate system onto the truck bed.

In some embodiments, the platform may be integrated into or installed onto the truck bed without tracks, such that the platform does not slide within the bed.

In some aspects, the platform may include one or more collapsible storage bins that may be disposed on the top surface of the platform. The one or more collapsible storage bins may be integrated with the platform. The collapsible storage bins generally have sidewalls that may be held in an upright position by an interference fit and/or with any suitable hardware, such as braces and/or brackets.

In some embodiments, the collapsible storage bins may be integrated or installed onto the truck bed without a platform.

In further aspects, the platform may include a plurality of slots configured to receive removable storage bins. The removable storage bins may include a plurality of tabs disposed at a bottom surface of the removable storage bins. In some embodiments, the removable storage bins may snap into the platform.

In further aspects, each of the plurality of glides may be T-shaped, and each of the plurality of tracks may be U-shaped guide rail. In some aspects, the truck bed may include a plurality of bed grooves. The plurality of bed grooves may be configured to receive the plurality of tracks.

The platform included in the vehicle, as disclosed in the present disclosure, facilitates convenient storage of multiple items in a vehicle cargo bed/truck bed. The items stored in the platform do not slide when the vehicle moves. Further, the platform is configured to slide in and out of the truck bed; hence, the user is not required to climb the truck bed multiple times to store the items on the truck bed.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 is a perspective view of a truck with a platform in a first position in accordance with the present disclosure;

FIG. 2 is a perspective view thereof, shown in a second position;

FIG. 3 is an exploded view thereof;

FIG. 4 is a bottom plan view thereof;

FIG. 5 is a side view thereof;

FIG. 6 is a detail side view thereof;

FIG. 7 depicts first steps of unfolding a storage area thereof;

FIG. 8 depicts second steps of unfolding the storage area thereof;

FIG. 9 depicts an alternate embodiment of a truck and a platform connection in accordance with the present disclosure;

FIG. 10 is an exploded view thereof;

FIG. 11 is a sectional view thereof, taken along line 11-11 of FIG. 9;

FIG. 12 depicts an alternative platform in accordance with present disclosure; and

FIG. 13 depicts an embodiment of a two-tier installation in accordance with the present disclosure.

### DETAILED DESCRIPTION OF INVENTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

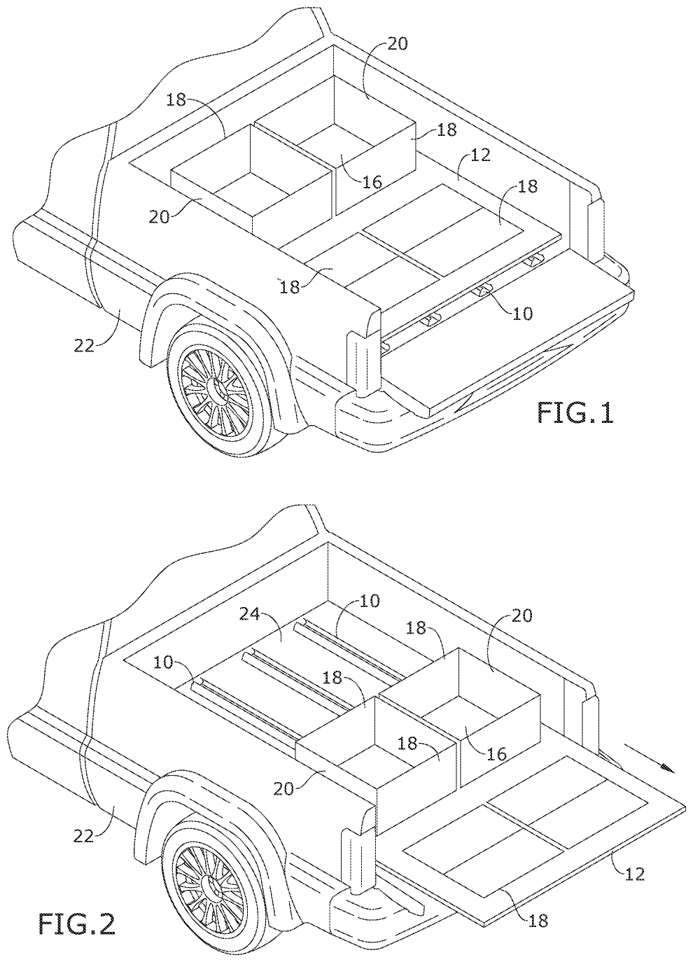

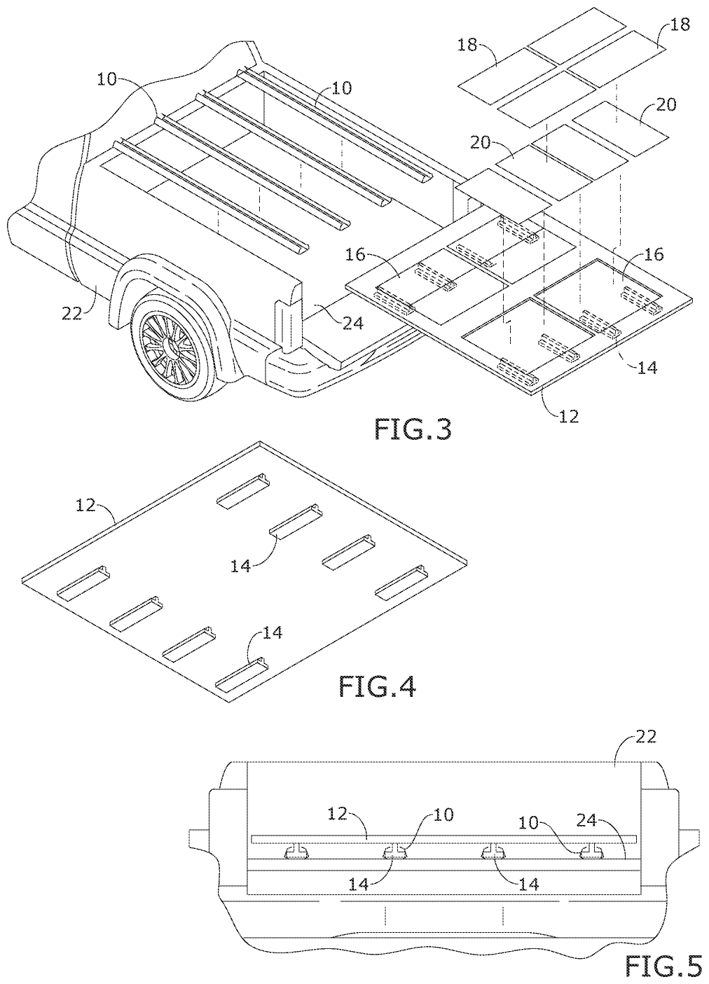

FIG. 1 depicts a perspective view of a truck 22 with a platform 12 in a first position accordance with the present disclosure. FIG. 1 will be described in conjunction with FIGS. 2-8. The platform 12 may be disposed on a truck bed 24 (shown in FIG. 2). In some aspects, the platform 12 may be disposed on the truck bed 24 via tracks 10. Specifically, the tracks 10 may be attached to the truck bed 24, and the platform 12 may be disposed over the tracks 10. The tracks 10 may be guide-rails on which the platform 12 may slide in and out of the truck bed 24. Stated another way, the platform 12 may be a movable platform that may be configured to slide on the tracks 10 to move in and out of the truck 22 (e.g., between the first position and a second position). FIG. 1 depicts the first position in which the platform 12 may cover or overlay the complete truck bed 24 (e.g., when the platform 12 may be inside the truck 22). FIG. 2 depicts the second position of the platform 12 in which the platform 12 may uncover the truck bed 24 (completely or partially, for example, when the platform 12 may be outside the truck bed 24). In an exemplary aspect, the truck bed 24 may include a plurality of tracks 10 (e.g., four tracks 10) that may be attached to the truck bed 24 via fasteners (e.g., bolts).

In some aspects, the platform 12 may include platform slots 16 that may be disposed at a top surface of the platform 12. The platform 12 may include any number/count of platform slots 16, which may be integrated to the platform 12. For example, the platform 12 may include four platform slots 16 of same or different sizes. In an exemplary aspect, the platform slots 16 may be cavities of any shape and size. In some aspects, the platform slots 16 may be rectangular in shape, and periphery of the platform slots 16 may be attached with long container walls 18 and short container walls 20. In some aspects, the platform slots 16 may be reconfigurable slots, and the long and short container walls 18, 20 may be collapsible. Stated another way, the long container walls 18 and the short container walls 20 may be configured to fold inside the platform slots 16. In an exemplary aspect, there may be four walls for each platform slot 16, which may be integrated to the platform 12.

In some aspects, the long container walls 18 and the short container walls 20 may be integrated to the platform 12, and may be collapsible. Further, the platform slots 16 may be adjustable. In an exemplary aspect, the walls (e.g., long container walls 18) associated with the four platform slots 16 (or two platform slots 16) may be used to form a single large sized bin or container. In some aspects, a wall brace may be used between the walls to form the large sized bin or container. Stated another way, the bin or container formed by the platform slots 16, and the long and short container walls 18, 20 may have the capability to extend in length and width, based on requirements. A user may place items in the platform slots 16 (specifically in the bin/container formed by the platform slots 16, and the long and short container walls 18, 20) when the user desires to store the items on the truck bed 24. The long and short container walls 18, 20 may ensure that the items do not slide or get damaged when the truck 22 moves.

A user may keep the long container walls 18 and the short container walls 20 folded when the platform slots 16 may be not be required to store the items, and may unfold the long container walls 18 and the short container walls 20 when the user desires to store the items in the platform slots 16. The walls 18 and 20 prevent movement of items during vehicle movement. FIG. 7 depicts first steps to unfold the long container walls 18 to form the container/bin described above, and FIG. 8 depicts second steps to unfold the short container walls 20. Specifically, FIG. 7 depicts a view where the long container walls 18 are unfolded, and FIG. 8 depicts a view where the short container walls 20 are unfolder to form the bin/container described above. In an exemplary aspect, the user may unfold the long container walls 18 first (as shown in FIG. 7), and then unfold the short container walls 20 after the long container walls 18 are unfolded (as shown in FIG. 8). In other aspects, the user may follow a reverse order of unfolding the walls, without departing from the scope of the present disclosure. Operation of the system may be performed manually or the track and rail system can be motorized using any suitable means known in the art, and may include, for example, gears and/or pulleys.

In some aspects, the platform 12 may further include glides 14 at a bottom surface of the platform 12 (as shown in FIGS. 4-6). The glides 14 are configured to engage with the tracks 10 to facilitate sliding movement of the platform 12. The glides 14 may be configured to be inserted in the tracks 10, and may move inside the tracks 10 in and out to facilitate sliding of the platform 12 on the truck bed 24. In some aspects, the glides 14 may include castor/slider/roller that may facilitate the platform 12 to move on the tracks 10. In some aspects, the glides 14 may include a locking mechanism (not shown) that may be configured to lock/secure the glides 14 inside the tracks 10, which may prevent movement of the platform 12 during truck movement. The glides 14 may be of any shape and size.

The platform 12 may include any number of glides 14 that may be arranged in any pattern. For example, the platform 12 may include eight glides, out of which four glides (a “first set of glides”) may be located in proximity to a front edge of the platform 12, and the remaining four glides (a “second set of glides”) may be located in proximity to a rear edge of the platform 12. The first set of glides may be disposed in alignment with the second set of glides. In further aspects, all the glides 14 may be of same shape and dimensions.

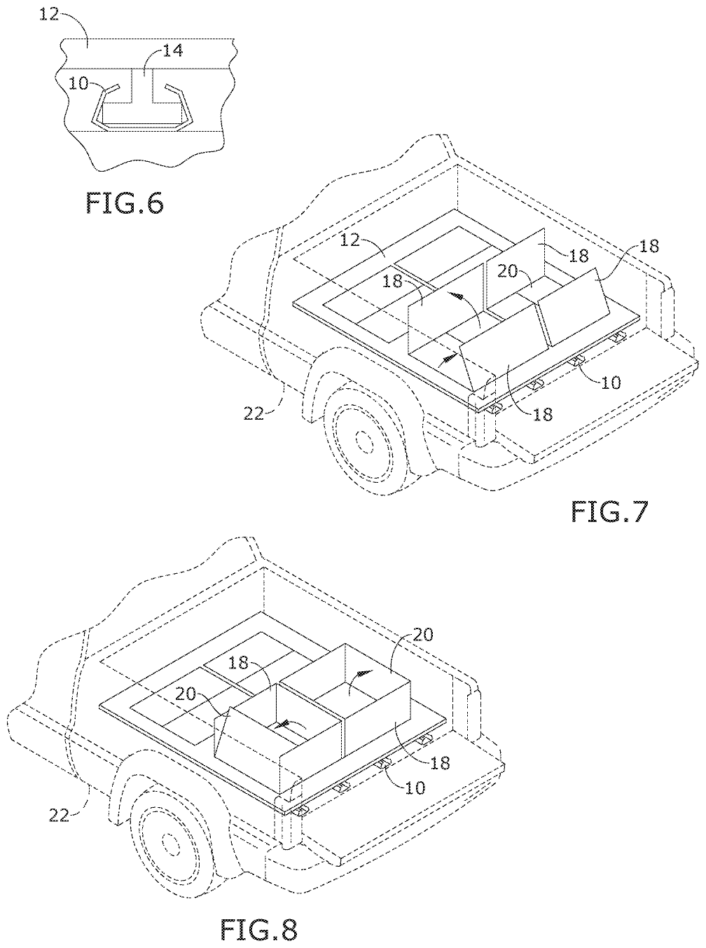

In some aspects, each glide 14 may include a first portion and a second portion. The first portion may be connected to the bottom surface of the platform 12 and the second portion may be configured to be inserted in the track 10 (as shown in FIGS. 5-6). A plane of the second portion may be disposed perpendicular to a plane of the first portion and may be connected with each other to form an inverted T-shape, as shown in FIGS. 4-6. In some aspects, the tracks 10 may be U-shaped rails that may be configured to receive the second portion, and secure the second portion such that the second portion may not come out of the tracks 10. The second portion may be configured to slide in and out in the tracks 10 to enable the platform 12 to conveniently move between the first position and the second position on the truck bed 24.

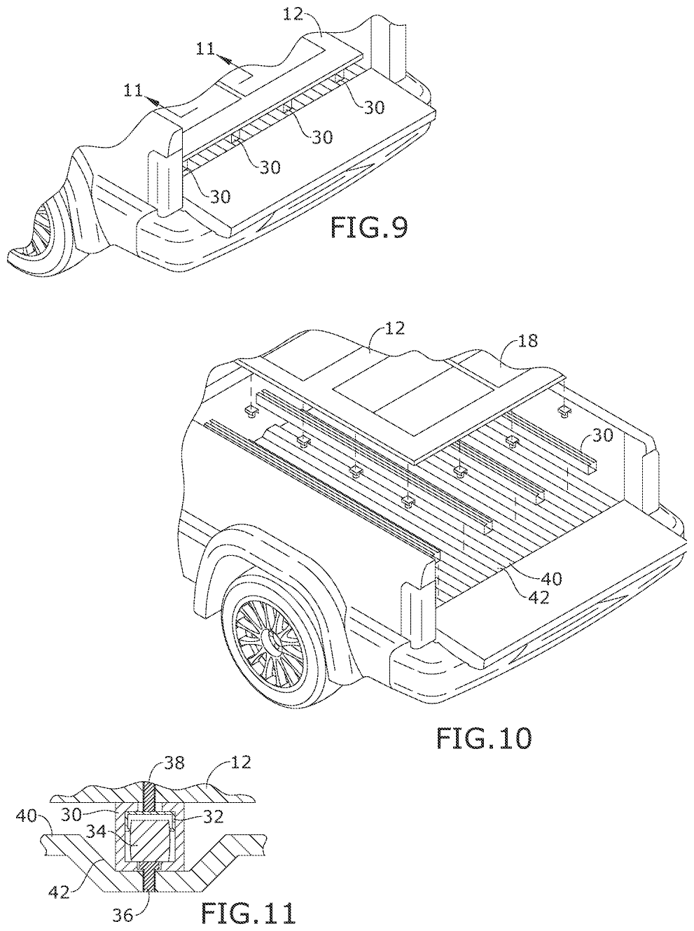

FIG. 9 depicts an alternate embodiment of the truck 22 and the platform 12 connection in accordance with the present disclosure. In this embodiment, the truck 22 may include a truck bed 40 having bed grooves 42 (as shown in FIG. 10). The truck bed 40 may be secured to the truck frame using one or more fasteners (e.g., a frame bolt 36, shown in FIG. 11). In some aspects, the bed grooves 42 may extend over the length of the truck bed 40. In other aspects, the bed grooves 42 may extend over a portion of the length of the truck bed 40. The platform 12 may be disposed over the truck bed 40 via tracks 30 (e.g., through or by using a platform bolt 38). In some aspects, the tracks 30 may be inserted in the bed grooves 42. In some aspects, the tracks 30 may include U-shaped rails, and may be same as the tracks 10. Alternatively, the tracks 30 may be different from the tracks 10. In some aspects, the platform 12 may be configured to slide in the tracks 30 using a slider 34 located in a slider frame 32 (as shown in FIG. 11).

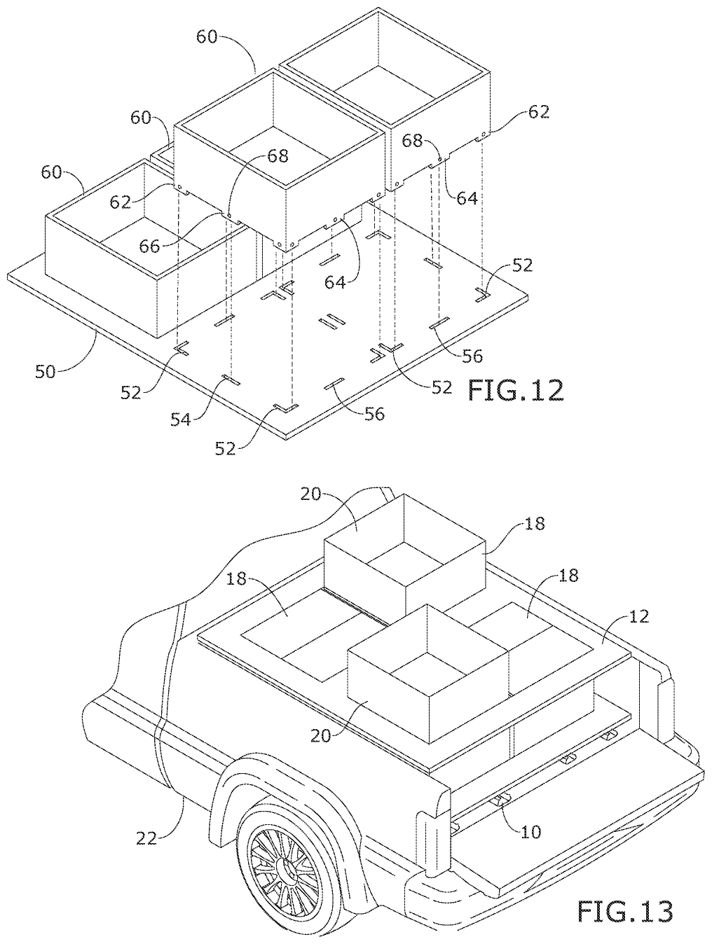

FIG. 12 depicts an alternative platform 50 in accordance with present disclosure. The platform 50 may include a plurality of slots (or slits) that may be arranged in a predetermined pattern. In an exemplary aspect, there may be eight slots on the platform 50. The plurality of slots may be configured to receive removable bins 60 (or snap-in containers). Stated another way, the platform 50 may be configured to receive external containers, which may not be integrated to the platform 50. The removable bins 60 may be removably attached to the platform 50. The removable bins 60 may be hollow boxes of any shape and dimensions. The removable bins 60 may include walls (similar to the walls 18 and 20 described above); however, the walls of the removable bins 60 may not be collapsible. In other aspects, the walls of the removable bins 60 may be collapsible. In these aspects, the bins 60 function in the same manner as the integrated bins discussed above, such that each bin 60 may have its walls in an open position, in a closed position, or in a combination thereof, such as having adjacent bins with the facing walls folded down to serve as a single, larger bin.

The plurality of slots may include corner slots 52, short side slots 54, and long side slots 56 for each removable bin 60, which may of different shapes and sizes. The removable bin 60 may include a plurality of tabs at a bottom surface of the removable bin 60, which may be snapped-in to the plurality of slots to secure the removable bin 60 at the platform 50. In an exemplary aspect, there may be eight tabs on the removable bin 60. The plurality of tabs may include corner tabs 62, short side tabs 64, and long side tabs 66, which may of different shapes and sizes. The corner tabs 62 may be inserted into the corner slots 52, the short side tabs 64 may be inserted into the short side slots 54, and the long side tabs 66 may be inserted into the long side slots 56. Each removable bin 60 may include retention nubs 68 to retain the removable bins 60 on the platform 50, and ensure that the bins 60 do not slide or move when the truck 22 moves. In some aspects, the removable bin 60 may include handles for user convenience.

FIG. 13 depicts an embodiment of a two-tier installation in accordance with the present disclosure. As shown in FIG. 13, a plurality of platforms 12 may be placed one over the other on the truck bed 24. In this case, each platform 12 may be configured to move slidably in and out of the truck bed 24 in the manner described above. Structural details of the platform 12 depicted in FIG. 13 are same as the details described above, and hence are not described again here for the sake of simplicity and conciseness.

In some aspects, the platforms 12 and 50 may be configured to expand along the length of the truck bed 24 and height of the truck bed 24. The platforms 12, 50 may have four platform extension provisions (not shown), two on each side of the platforms 12, 50. In some aspects, the platforms 12, 50 may include 3 portions, each portion may be configured to cover ⅓ of the truck bed 24. When the platform 12,50 is extended, the platform 12, 50 may be configured to be secured onto the truck bed 24 using fasteners, brackets, etc.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

The claimed invention is:

1. A vehicle comprising:
a truck bed having a plurality of tracks;
a platform disposed over the truck bed, wherein the platform comprises a top surface and a bottom surface; and
a plurality of glides attached to the bottom surface of the platform, wherein the plurality of glides is operative to engage with the plurality of tracks, and wherein the plurality to glides is operative to slide in the respective tracks to enable the platform to slide in and out of the truck bed.

2. The vehicle of claim 1, wherein the platform comprises one or more collapsible storage bins that are disposed on the top surface of the platform.

3. The vehicle of claim 2, wherein the one or more collapsible storage bins are integrated with the platform.

4. The vehicle of claim 1, wherein the platform comprises a plurality of slots configured to receive removable storage bins.

5. The vehicle of claim 4, wherein the removable storage bins comprise a plurality of tabs disposed at a bottom surface thereof, and wherein the plurality of tabs are couplable with the plurality of slots.

6. The vehicle of claim 1, wherein each of the plurality of glides is T-shaped.

7. The vehicle of claim 1, wherein each of the plurality of tracks is U-shaped guide rail.

8. The vehicle of claim 1, wherein the truck bed comprises a plurality of bed grooves, and wherein the plurality of bed grooves is configured to receive the plurality of tracks.

9. A vehicle comprising:
a truck bed having a plurality of tracks;
a platform disposed over the truck bed, wherein the platform comprises a top surface and a bottom surface;
a plurality of glides attached to the bottom surface of the platform, wherein the plurality of glides is operative to engage with the plurality of tracks, and to slide in the respective tracks such that the platform slides in and out of the truck bed; and
one or more collapsible storage bins integrated to the top surface of the platform.

10. The vehicle of claim 9, wherein each of the plurality of glides is T-shaped.

11. The vehicle of claim 9, wherein each of the plurality of tracks is U-shaped guide rail.

12. A container system for installation onto a truck bed, comprising:
a platform having a top surface and a bottom surface; and
at least one storage bin, having sidewalls, coupled to the top surface.

13. The container system of claim 12, wherein the bottom surface further comprises a sliding track system operative to slidably fasten the platform to the truck bed.

14. The container system of claim 12, wherein the sidewalls are operative to foldably move between a collapsed storage position and an erect use position.

15. The container system of claim 12, wherein the at least one storage bin is removable from the top surface.
